(19) United States
(12) Patent Application Publication
(10) Pub. No.: US 2025/0365234 A1
(43) Pub. Date: Nov. 27, 2025

(54) FLOW ENTROPY MANAGEMENT USING NETWORK ADDRESS TRANSLATION SCHEME

(71) Applicant: Cisco Technology, Inc., San Jose, CA (US)

(72) Inventor: Harsha Bharadwaj, BANGALORE (IN)

(21) Appl. No.: 18/674,663

(22) Filed: May 24, 2024

(51) Int. Cl. H04L 47/125; H04L 47/122; H04L 47/41

(52) U.S. Cl. CPC H04L 47/125; H04L 47/122; H04L 47/41

(57) ABSTRACT

Devices, systems, methods, and processes for flow entropy management using network address translation (NAT) scheme are described herein. Typically, due to fewer flows and high bandwidth demands in backend data center networks, hash distribution algorithms may exhibit bias, leading to congestion on certain network paths while others remain underutilized, a phenomenon known as low flow entropy. To address the low flow entropy problem, a network interface controller (NIC) decomposes a traffic flow into multiple flowlets and applies a NAT operation on each flowlet. In the NAT operation, an actual source port value of a flowlet is replaced with a unique unused source port value to make the flowlet look like a different traffic flow to a switch. Thus, the switch processes each flowlet as a different traffic flow and uses load balancing schemes to distribute the flowlets across various network paths. Thus, improving the flow entropy of the network.

The present disclosure relates to communications. More particularly, the present disclosure relates to managing flow entropy using a flowlet-based network address translation (NAT) scheme at network interface controller (NIC) level.

### BACKGROUND

In front-end data center (DC) networks, complexity of storage accesses, microservices, and serverless architectures typically leads to millions of potential traffic flows. Thus, for a given switch in the front-end DC network, the traffic flows can be in the order of several thousands, resulting in effective load balancing through hash distribution across equal-cost multipaths (ECMPs) at the switch.

However, in backend DC networks, where graphics processing units (GPUs) communicate via Remote Direct Memory Access (RDMA) over Converged Ethernet version 2 (RoCEv2) Reliable Connection (RC) protocol, multiple GPU to GPU communication requirements can at the most result in several thousand flows. Thus, for a given switch in a backend DC network, the number of flows can be up to a few hundreds and the switch is required to make all ECMP load balancing decisions based on these few hundred flows.

With fewer flows and high bandwidth demands in the backend DC network, hash distribution algorithms may exhibit bias, leading to congestion on certain ECMP paths while others remain underutilized, a phenomenon known as low flow entropy. To address the flow entropy problem, solutions like Dynamic Load Balancing (DLB) and packet spraying are employed. While these solutions offer avenues to mitigate low flow entropy, their effectiveness depends on network infrastructure and compatibility constraints.

### SUMMARY OF THE DISCLOSURE

Systems and methods for managing flow entropy using network address translation in accordance with embodiments of the disclosure are described herein. In many embodiments, a device includes a processor, a network interface controller (NIC) configured to provide access to a network, and a memory communicatively coupled to the processor. The memory includes a flow entropy management logic that is configured to identify a flowlet of a traffic flow, wherein the flowlet is associated with a source port value, obtain a unique unused source port value in response to identifying the flowlet, replace the source port value associated with the flowlet with the unique unused source port value, and transmit the flowlet having the unique unused source port value to a destination.

In a number of embodiments, the flowlet includes at least one packet.

In a variety of embodiments, one or more headers of the at least one packet include the source port value.

In additional embodiments, replacing the source port value includes replacing the source port value in the one or more headers of the at least one packet with the unique unused source port value.

In more embodiments, the flow entropy management logic identifies the flowlet based on an inter-packet gap exceeding a threshold value.

In still more embodiments, the threshold value is a round-trip time associated with the destination.

In further embodiments, the flow entropy management logic is further configured to determine the round-trip time associated with the destination.

In additional embodiments, the flow entropy management logic determines the round-trip time based on one or more response times associated with the destination.

In further additional embodiments, to determine the round-trip time, the flow entropy management logic is further configured to transmit a probe packet to the destination. The probe packet includes a source timestamp. The flow entropy management logic is further configured to receive a probe response from the destination in response to transmitting the probe packet. The probe response includes the source timestamp and a destination processing time value. The flow entropy management logic is further configured to determine a time of arrival of the probe response. The round-trip time is determined based on the source timestamp, the destination processing time value, and the time of arrival.

In yet more embodiments, the flow entropy management logic is further configured to periodically update the round-trip time associated with the destination.

In still yet more embodiments, to obtain the unique unused source port value, the flow entropy management logic is further configured to look-up in a flow table and select, from a plurality of source port values, a unique source port value that is absent in the flow table. The selected unique source port value corresponds to the unique unused source port value.

In several embodiments, the flow entropy management logic is further configured to store the unique unused source port value in the flow table in response to the replacement of the source port value with the unique unused source port value.

In several more embodiments, the flow table is configured to maintain an outstanding flow state on a per-port basis of the device.

In several additional embodiments, the flow entropy management logic is further configured to store in a mapping table, a mapping between the source port value and the unique unused source port value.

In various embodiments, the flow entropy management logic is further configured to receive at least one response packet in response to transmitting the flowlet. The at least one response packet includes, as a destination port value, the unique unused source port value. The flow entropy management logic is further configured to obtain, from the mapping table, the source port value mapped to the unique unused source port value, replace the destination port value in the at least one response packet with the obtained source port value, and transmit the at least one response packet having the replaced source port value to a corresponding source port.

In many further embodiments, the NIC is further configured to execute the flow entropy management logic.

In still yet further embodiments, a device includes a processor, a network interface controller configured to provide access to a network, and a memory communicatively coupled to the processor. The memory includes a flow entropy management logic that is configured to receive, from a source device, a plurality of flowlets of a traffic flow, obtain mapping information stored in one or more mapping tables at the source device, aggregate the plurality of flowlets based on the obtained mapping information, and determine flow level information of the traffic flow based on the aggregation of the plurality of flowlets. The plurality of flowlets are associated with unique source port values.

In still more embodiments, the mapping information is obtained based on a link layer handshake protocol with the source device.

In still further embodiments, the flow entropy management logic is further configured to execute a flow hashing operation on the plurality of flowlets to forward the plurality of flowlets to one or more corresponding destinations.

In further additional embodiments, a method includes identifying a flowlet of a traffic flow, wherein the flowlet is associated with a source port value, obtaining a unique unused source port value in response to identifying the flowlet, replacing the source port value associated with the flowlet with the unique unused source port value, and transmitting the flowlet having the unique unused source port value to a destination.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of an example architecture for a network fabric in accordance with various embodiments of the disclosure;

FIG. 2 is a schematic block diagram of an example computing system in accordance with various embodiments of the disclosure;

FIG. 3 is a schematic block diagram of a part of an example computing system that employs a flowlet-based network address translation (NAT) operation at network interface (NIC) level for flow entropy management in accordance with various embodiments of the disclosure;

FIG. 4 is a flowchart showing a process for flow entropy management in accordance with various embodiments of the disclosure;

FIG. 5 is a flowchart showing a process for flow entropy management in accordance with various embodiments of the disclosure;

FIG. 6 is a flowchart showing a process for determining a round-trip time (RTT) associated with a destination in accordance with various embodiments of the disclosure;

FIG. 7 is a flowchart showing a process for routing NAT-operated flowlets of a traffic flow in accordance with various embodiments of the disclosure; and

FIG. 8 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that utilize a flowlet-based network address translation (NAT) operation at a network interface controller (NIC) to manage flow entropy. In the realm of Artificial Intelligence (AI)/Machine learning (ML) workloads, handling large datasets and models, for example, Large Language Models (LLMs), presents a significant challenge. Offloading computations to multiple graphics processing units (GPUs) accelerates tasks, but often exceeds a single GPU's memory capacity. To address this concern, AI/ML frameworks distribute data and computations across multiple GPU nodes in clusters. High-performance data center (DC) networks (for example, backend DC networks) primarily comprise GPUs, necessitating efficient interconnection via a high-speed network.

Remote Direct Memory Access (RDMA) over Converged Ethernet version 2 (RoCEv2) Reliable Connection (RC) has emerged as a pivotal protocol facilitating fast communication between GPUs in the backend DC networks. Thus, a lot of bulk data can be exchanged between GPUs using RoCEv2 RC protocol. These multiple GPU to GPU communication requirements can at the most result in several thousand flows. Thus, for a given switch in a backend DC network, the number of flows can be up to a few hundreds and the switch is required to make all decisions for hash distribution load balancing across equal-cost multipaths (ECMPs) based on these few hundred flows. With fewer flows and high bandwidth demands in the backend DC network, hash distribution algorithms may exhibit bias, leading to congestion on certain ECMP paths while others remain underutilized, a phenomenon known as low flow entropy.

To address the flow entropy problem, solutions like Dynamic Load Balancing (DLB) and packet spraying are employed. DLB identifies flowlets within a flow and dynamically selects different ECMP paths based on link congestion, effectively increasing flow entropy by decomposing fewer flows into potentially thousands of flowlets. However, DLB relies on congestion feedback signals such as Explicit Congestion Notification, which can be interfered with by features like Priority Flow Control (PFC) in RoCEv2 networks, leading to suboptimal load balancing decisions. Packet spraying is another approach that involves distributing individual packets of a flow across all available ECMP paths. While promising, it requires support from switches with the latest Hardware, and programming via P4 may be necessary. Additionally, packet spraying depends on destination network interface controller (NIC) capabilities for reassembly, which may not be universally supported. Alternatively, reassembly at a leaf switch egress port requires significant resources, making it potentially impractical. Thus, while these solutions offer avenues to mitigate low flow entropy, their effectiveness depends on network infrastructure and compatibility constraints.

In many embodiments, one or more GPUs (for example, in a sending device) may be coupled to a NIC. The NIC may be configured to identify a plurality of flowlets in a traffic flow originating from any of the GPUs and apply a NAT operation on each flowlet to make the flowlet look like a different traffic flow to a switching fabric (e.g., leaf and spine switches) connected to the NIC. Thus, the switch (e.g., the leaf switch) processes each flowlet as a different traffic flow and uses an ECMP hashing scheme to distribute the received plurality of flowlets across various ECMP paths in a network. In other words, the NIC can decompose a traffic flow into a plurality of flowlets and based on the NAT operation each flowlet appears as a different traffic flow to the switching fabric in both ingress/egress directions. Thus, improving the flow entropy of the network.

In a number of embodiments, the traffic flow may include a plurality of packets and each flowlet may include at least one packet. The NIC can identify a flowlet within the traffic flow based on an inter-packet gap exceeding a threshold value. In other words, a flowlet may refer to a group of packets (e.g., one or more packets) within the traffic flow that are separated by a time duration greater than the threshold value from a preceding packet of the same traffic flow. Further, inter-packet gap between two successive packets within the flowlet is less than the threshold value. In a scenario where a flowlet includes a single packet, the packet is separated by a duration greater than the threshold value from a preceding packet and also from a succeeding packet of the same traffic flow. In many examples, the threshold value can be a round-trip time (RTT) associated with a destination of the traffic flow or the network. The RTT may correspond to the time taken for a packet to travel from a source to a destination and then back to the source.

In numerous embodiments, the RTT can be determined by using a static method or a dynamic method. In the static method, based on response times associated with packets, an average RTT for a destination is determined. For example, the NIC may determine the time (e.g., response time) it takes to receive an acknowledgement (ACK) or a negative ACK (NACK), for each transmitted packet, from a destination. The NIC may then determine an average of these response times to determine the RTT associated with the destination. In the dynamic method, the RTT is determined by utilizing special probe packets. For example, the NIC may transmit a probe packet, comprising a source timestamp, to the destination and in turn may receive a probe response from the destination. The probe response may include the source timestamp and a destination processing time value. The destination processing time value may indicate the time taken at the destination to process the probe packet and generate the probe response. Further, the NIC may determine a time of arrival of the probe response. The NIC may utilize the source timestamp, the destination processing time value, and the time of arrival to determine the RTT. RTT determined based on the dynamic method may be more accurate as compared to the static method. Therefore, in scenarios, where precise RTTs are required, the dynamic method may be utilized.

In a variety of embodiments, one or more headers of each packet in the identified flowlet may include a source port field and the source port field may contain a source port value. All packets belonging to the same traffic flow are assigned the same source port value. As a result, the one or more packets in the flowlet are also associated with the same source port value. Typically, the source port field is a 16 bits long field. Thus, there can be 2¹⁶ unique source port values. Of these 2¹⁶ source port values, values that are already assigned to outstanding traffic flows at a port are stored in a flow table by the NIC.

Upon identifying the flowlet within the traffic flow, the NIC may apply the NAT operation on the identified flowlet. To apply the NAT operation, the NIC may obtain a unique unused source port value and replace the source port value associated with the flowlet with the unique unused source port value. The NIC may obtain the unique unused source port value based on the flow table. For example, from the 2¹⁶ source port values, the values that are absent in the flow table can be considered unused by the NIC. Thus, the NIC may look-up in the flow table and select a unique source port value that is absent in the flow table as a replacement candidate for the source port value. In other words, the NIC can select any of these unused values to replace the source port value associated with the flowlet. To replace the source port value with the unique unused source port value, the NIC may replace the source port value in the one or more headers of each packet in the flowlet with the unique unused source port value. In other words, the NIC may re-write the unique unused source port value in the source port field of each packet in the identified flowlet.

In numerous more embodiments, the NIC may store a mapping between the source port value and the unique unused source port value in a mapping table for future look-up. Based on successfully applying the NAT operation, the NIC may transmit the flowlet (e.g., each packet in the flowlet) to a destination via the switching fabric. In numerous additional embodiment, the NIC may be implemented using a portable NIC architecture.

In more embodiments, the NIC may be communicatively coupled to a switch (e.g., a leaf switch) in the switching fabric. The switch may receive, from the NIC, the plurality of flowlets of the traffic flow. Since each flowlet is associated with a different source port value due to the NAT operation implemented at the NIC, each flowlet appears as a different traffic flow to the switch. The switch may execute one or more load balancing operations on the plurality of flowlets to distribute the plurality of flowlets across various ECMP paths in the network. For example, the switch may execute an ECMP hashing scheme based on 5-tuple on the plurality of flowlets to distribute the plurality of flowlets across the ECMP paths.

In additional embodiments, the switch may obtain mapping information stored in one or more mapping tables at the sending device. For example, the switch may utilize a link layer handshake protocol (e.g., Link Layer Discovery Protocol) to obtain the content of the mapping table maintained by the NIC on a port basis. The switch may then aggregate the plurality of flowlets based on the obtained mapping information and determine flow level information of the traffic flow based on the aggregation of the plurality of flowlets. In various embodiments, the switch may store the determined flow level information in various flow related databases (for example, NetFlow® feature developed by Cisco) associated with the switch.

In several embodiments, the NIC may receive one or more response packets (e.g., ACKs or NACKs) in response to transmitting each flowlet of the plurality of flowlets. Each response packet may include, as a destination port value in a destination port field, the unique unused source port value associated with the corresponding flowlet. The NIC may perform a reverse look-up in the mapping table and obtain the source port value mapped to the unique unused source port value. The NIC may replace the destination port value in each response packet with the obtained source port value and transmit the response packet having the replaced source port value to a corresponding source port for further processing. Applying NAT operation at NIC level ensures that the NAT operation is transparent to higher level RoCEv2 protocol software and hardware, and does not require any changes in them.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in various embodiments, may alternatively be embodied by or implemented as a component.

A circuit, as used herein, comprises a set of one or more electrical and/or electronic components providing one or more pathways for electrical current. In various embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in various embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

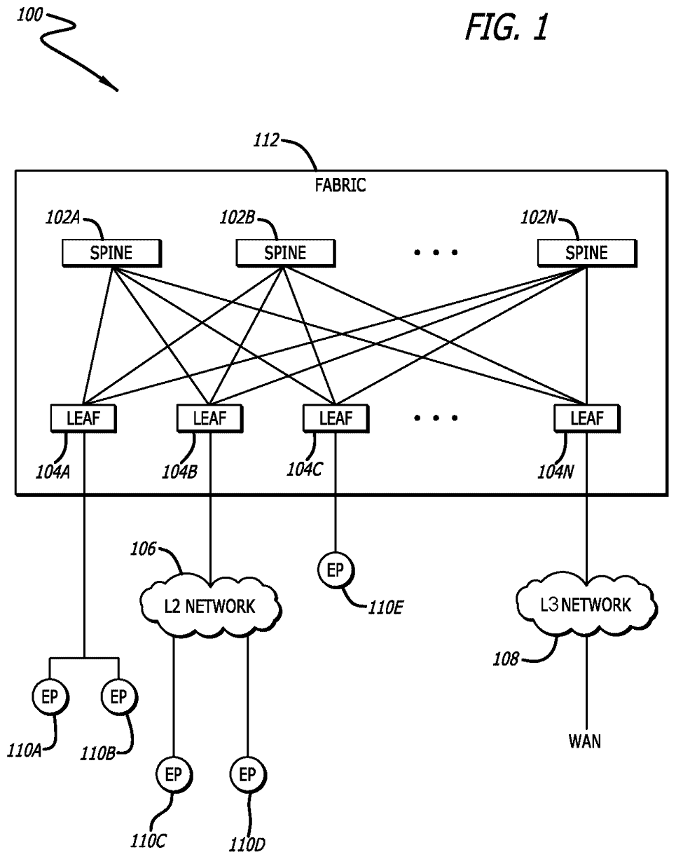

Referring to FIG. 1, a schematic block diagram of an example architecture 100 for a network fabric 112 in accordance with various embodiments of the disclosure is shown. The network fabric 112 can include spine switches 102A, 102B, . . . 102N (collectively “102”) connected to leaf switches 104A, 104B, 104C, . . . 104N (collectively “104”) in the network fabric 112. As those skilled in the art will recognize, networking fabric can refer to a high-speed, high-bandwidth interconnect system that enables multiple devices to communicate with each other efficiently and reliably. It is a network topology that is designed to provide a flexible and scalable infrastructure for data center, cloud environments, and other network elements.

Various embodiments described herein can include a leaf-spine architecture comprising a plurality of spine switches and leaf switches. Spine switches 102 can be L3 switches in the fabric 112. An L3 switch, or Layer 3 switch, is a networking device that operates at a network layer (Layer 3) of Open Systems Interconnection (OSI) model. However, in some cases, the spine switches 102 can also, or otherwise, perform L2 (e.g., Layer 2 of OSI model) functionalities. Further, the spine switches 102 can support various capabilities, such as, but not limited to, 40 or 10 Gbps Ethernet speeds. To this end, the spine switches 102 can be configured with one or more 40 Gigabit Ethernet ports. In various embodiments, each port can also be split to support other speeds. For example, a 40 Gigabit Ethernet port can be split into four 10 Gigabit Ethernet ports, although a variety of other combinations are available.

In many embodiments, one or more of the spine switches 102 can be configured to host a proxy function that performs a lookup of the endpoint address identifier to locator mapping in a mapping database on behalf of leaf switches 104 that do not have such mapping. The proxy function can do this by parsing through the packet to the encapsulated tenant packet to get to the destination locator address of the tenant. The spine switches 102 can then perform a lookup of their local mapping database to determine the correct locator address of the packet and forward the packet to the locator address without changing certain fields in the header of the packet.

In various embodiments, when a packet is received at a spine switch 102, wherein subscript “i” indicates that this operation may occur at any spine switch 102A to 102N, the spine switch 102; can first check if the destination locator address is a proxy address. If so, the spine switch 102; can perform the proxy function as previously mentioned. If not, the spine switch 102; can look up the locator in its forwarding table and forward the packet accordingly.

In a number of embodiments, one or more spine switches 102 can connect to one or more leaf switches 104 within the fabric 112. Leaf switches 104 can include access ports (or non-fabric ports) and fabric ports. Fabric ports can provide uplinks to the spine switches 102, while access ports can provide connectivity for devices, hosts, endpoints, VMs, or external networks to the fabric 112.

In more embodiments, leaf switches 104 can reside at the edge of the fabric 112, and can thus represent the physical network edge. In some cases, the leaf switches 104 can be top-of-rack (“ToR”) switches configured according to a ToR architecture. In other cases, the leaf switches 104 can be aggregation switches in any particular topology, such as end-of-row (EoR) or middle-of-row (MoR) topologies. The leaf switches 104 can also represent aggregation switches, for example.

In additional embodiments, the leaf switches 104 can be responsible for routing and/or bridging various packets and applying network policies. In some cases, a leaf switch can perform one or more additional functions, such as implementing a mapping cache, sending packets to the proxy function when there is a miss in the cache, encapsulate packets, enforce ingress or egress policies, etc. Moreover, the leaf switches 104 can contain virtual switching functionalities, such as a virtual tunnel endpoint (VTEP) function. Further, leaf switches 104 can connect the fabric 112 to an overlay network.

In further embodiments, network connectivity in the fabric 112 can flow through the leaf switches 104. Here, the leaf switches 104 can provide servers, resources, endpoints, external networks, or VMs access to the fabric 112, and can connect the leaf switches 104 to each other. In some cases, the leaf switches 104 can connect endpoint groups to the fabric 112 and/or any external networks. Each endpoint group can connect to the fabric 112 via one of the leaf switches 104, for example.

Endpoints 110 A-E (collectively “110”, shown as “EP”) can connect to the fabric 112 via leaf switches 104. For example, endpoints 110A and 110B can connect directly to leaf switch 104A, which can connect endpoints 110A and 110B to the fabric 112 and/or any other one of the leaf switches 104. Similarly, endpoint 110E can connect directly to leaf switch 104C, which can connect endpoint 110E to the fabric 112 and/or any other of the leaf switches 104. On the other hand, endpoints 110C and 110D can connect to leaf switch 104B via L2 network 106. Similarly, the wide area network (WAN) can connect to the leaf switches 104C or 104D via L3 network 108.

In various embodiments, endpoints 110 can include any communication devices, such as computers, servers, switches, routers, graphics processing units (GPUs), etc. In some cases, the endpoints 110 can include a server, hypervisor, or switch configured with a VTEP functionality which connects an overlay network with the fabric 112. The overlay network can host physical devices, such as servers, applications, endpoint groups, virtual segments, virtual workloads, etc. In addition, the endpoints 110 can host virtual workload(s), clusters, and applications or services, which can connect with the fabric 112 or any other device or network, including an external network. For example, one or more endpoints 110 can host, or connect to, a cluster of load balancers or an endpoint group of various applications.

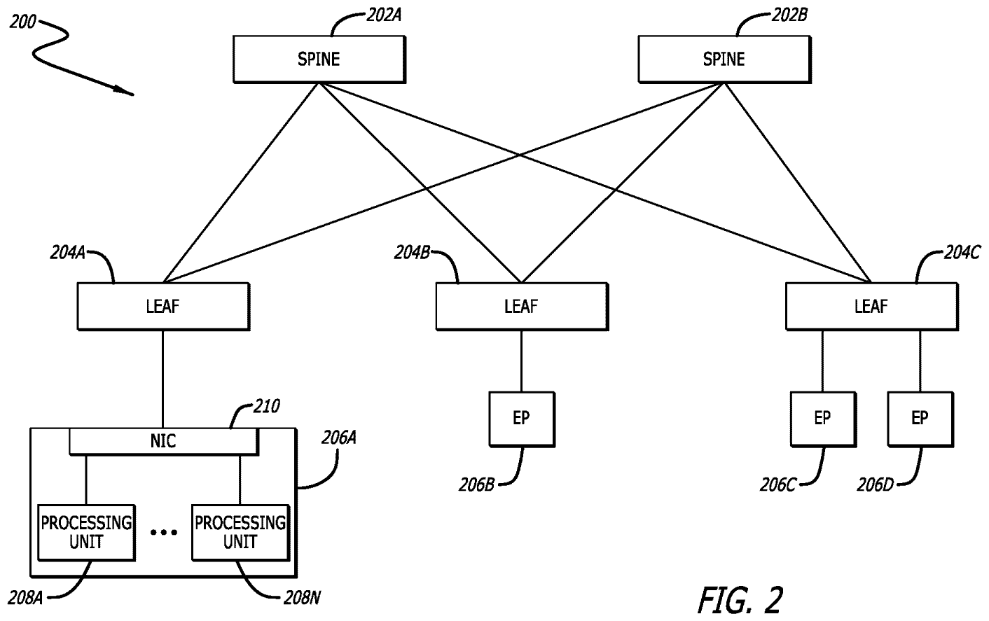

Although a specific embodiment for an architecture 100 is described above with respect to FIG. 1, any of a variety of systems and/or processes may be utilized in accordance with embodiments of the disclosure. For example, the architecture 100 could comprise any variety of endpoints, spine switches, and/or leaf switches. The elements depicted in FIG. 1 may also be interchangeable with other elements of FIGS. 2-8 as required to realize a particularly desired embodiment.

Referring to FIG. 2, a schematic block diagram of an example computing system 200 in accordance with various embodiments of the disclosure is shown. The computing system 200 can include first and second spine switches 202A and 202B (collectively “spine switches 202”) connected to first through third leaf switches 204A-C (collectively “leaf switches 204”), and first through fourth endpoint devices 206A-D (collectively “endpoint devices 206”) connected to the leaf switches 204. As those skilled in the art will recognize, the spine switches 202 and the leaf switches 204 can form a high-speed, high-bandwidth interconnect system (e.g., a switching fabric) that enables multiple devices (e.g., the endpoint devices 206) to communicate with each other efficiently and reliably. For example, the spine switches 202 and the leaf switches 204 may form a network based on a Remote Direct Memory Access (RDMA) based protocol, for example, RDMA over Converged Ethernet version 2 (RoCEv2) protocol. Further, the network may utilize the RDMA based protocol in a reliable connection (RC) mode. The computing system 200 may be used in various applications, such as, for example, backend data centers, systems providing cloud services, high-performance computing and distributed computing.

In many embodiments, the spine switches 202 are network devices that interconnect and facilitate communication between the leaf switches 204. The spine switches 202 may be configured to route traffic between different leaf switches 204. In many examples, the spine switches 202 can be L3 switches. Further, the spine switches 202 can support various capabilities, such as, but not limited to, 40 or 10 Gbps Ethernet speeds. For example, the spine switches 202 can be configured with one or more 40 Gigabit Ethernet ports to enable 40 Gbps Ethernet speeds. In a number of embodiments, each port can also be split to support other speeds. For example, a 40 Gigabit Ethernet port can be split into four 10 Gigabit Ethernet ports, although a variety of other combinations are available.

In a variety of embodiments, the leaf switches 204 are network devices that represent physical network edge. In many examples, the leaf switches 204 can be top-of-rack (“ToR”) switches configured according to a ToR architecture. In other examples, the leaf switches 204 can be aggregation switches in any particular topology, such as end-of-row (EoR) or middle-of-row (MoR) topologies. The leaf switches 204 may be configured to serve as connection points for the endpoint devices 206. Further, the leaf switches 204 may be configured to aggregate traffic from the endpoint devices 206 and forward it to the spine switches 202. The leaf switches 204 can function as ingress and egress switches. The leaf switches 204 may not be directly connected to each other, but can be connected indirectly through the spine switches 202. In many examples, a number of uplinks from a leaf switch is equal to a number of spine switches, and a number of downlinks from a spine switch is equal to the number of leaf switches.

In additional embodiments, the leaf switches 204 may be configured to execute one or more load balancing schemes on recipient traffic flows to distribute the traffic flows across various available uplink paths (e.g., links joining the leaf switches 204 to the spine switches 202). An example of such load balancing schemes may include Equal-Cost Multipath (ECMP) hashing. ECMP hashing operates by generating a hash value based on one or more header fields of incoming traffic flow packets, for example, source and destination Internet Protocol (IP) addresses, source and destination ports, and protocol type (also referred to as 5-tuple combination). The hash value is then utilized to determine which path or link the packet should take within the network.

In more embodiments, each leaf switch 204 may be further configured to maintain one or more routing tables containing information regarding the available paths to reach different destination endpoint devices. In many examples, when a leaf switch (any of the leaf switches 204) receives a packet, the leaf switch may apply the ECMP hashing algorithm on the packet to obtain a hash value and then select one of the available paths based on the hash value. The leaf switch may apply a modulo-n function on the hash value to select one of the available paths. Here ‘n’ may correspond to a count of the available ECMP paths. Typically, packets associated with the same 5-tuple combination are routed along the same path to preserve the order of packets and maintain integrity of RDMA communication.

In additional embodiments, the leaf switches 204 may be configured to maintain flow level information associated with the recipient traffic flows. Examples of the flow level information may include flow identifiers, quality of service (QOS) parameters (such as bandwidth allocation, priority class, latency requirements, or the like), active/inactive status of each traffic flow, or the like.

In further embodiments, an endpoint device 206; may comprise first through n^{th} processing units 208A-N (collectively referred to as “processing units 208”) and at least one network interface controller (NIC) 210 coupled to the processing units 208. Here, subscript “i” indicates that this configuration can be present in any endpoint device 206A-D. In FIG. 2, an exploded view of only one endpoint device 206A is shown for illustrative purposes. Examples of the endpoint devices 206 may include servers, IoT devices, mobile devices, or the like. In many examples, an endpoint device in the computing system 200 can also include a single processing unit without deviating from the scope of the disclosure.

The processing units 208 may include any suitable type of processors, graphic processing units (GPUs), or Central Processing Units (CPUs). The processing units 208 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In still more embodiments, the processing units 208 may be configured to leverage RDMA capabilities to execute data transfers. For example, a processing unit 208; may segment data or a message into one or more manageable units, for example, one or more packets, forming a traffic flow. Each packet may include a payload and one or more headers. Payload may include a segmented portion of the original data being transmitted. One or more headers may include various fields that store essential information about the corresponding packet and the traffic flow. The essential information may include, for example, source and destination IP addresses, source and destination port values, protocol details, or the like. Generally, packets belonging to the same traffic flow have the same source and destination IP addresses, the same source and destination port values, and the protocol details.

The NIC 210 may include a gigabit Ethernet adapter or any similar component that may connect endpoint device 206; to other devices in the network. The NIC 210 can provide the necessary interface (e.g., input ports and output ports) to manage and transmit the traffic flows generated by the processing units 208. In some examples, the NIC 210 may be implemented using a portable NIC architecture (PNA). PNA may comprise a programmable pipeline that facilitates the creation of different “data paths” between various ports on the device (e.g., network interfaces). Further, the pipeline may enable packet routing through these data paths, allowing adaptable network configuration. In addition, PNA may utilize P4 software to implement the data paths. In some examples, PNA may include a programmable main control block which can be used to process received packets and re-write data in packet headers.

In still further embodiments, the NIC 210 may be configured to execute a flow entropy management logic to prevent a low entropy phenomenon in the network. For example, the NIC 210 may apply a flowlet-based network address translation (NAT) operation on the traffic flows received from the processing units 208 for flow entropy management. The NIC 210 may identify a plurality of flowlets within a recipient traffic flow originating from any of the processing units 208 and apply the NAT operation on each flowlet to make the flowlet look like a different traffic flow to the connected leaf switch 204. For example, based on the NAT operation, the NIC 210 may replace (or substitute) a source port value associated each identified flowlet with a unique unused source port value, thus ensuring that the 5-tuple combination of each NAT-operated flowlet is unique. To replace the source port value of an identified flowlet with a unique unused source port value, the NIC 210 may replace the source port value in one or more headers of each packet of the identified flowlet with the unique unused source port value. Thus, the leaf switch 204 processes each NAT-operated flowlet as a different traffic flow and uses the load balancing scheme (e.g., ECMP hashing) to distribute the plurality of NAT-operated flowlets across various ECMP paths (e.g., uplinks connecting the spine switches 202) in the network.

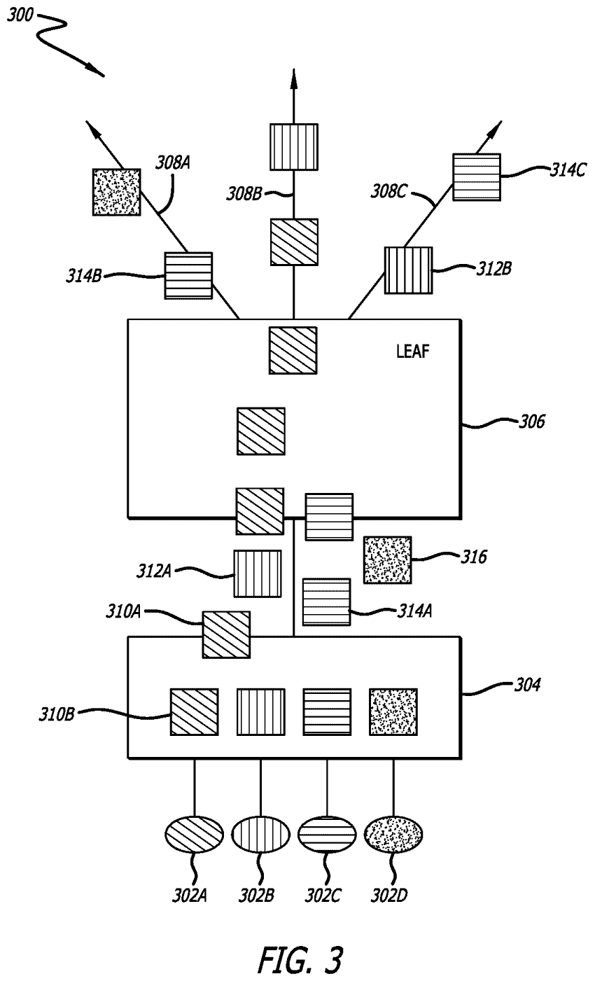

In still additional embodiments, the NIC 210 may be configured to receive one or more response packets, for example, acknowledgements (ACKs) or negative acknowledgements (NACKs), in response to transmitting each NAT-operated flowlet. The NIC 210 may be configured to apply a reverse NAT operation on the response packets to re-associate the response packets with the original source port value of the corresponding traffic flow. The flowlet-based NAT operation is described later in detail in conjunction with FIG. 3.

Thus, the flowlet-based NAT operation when executed at NICs (e.g., the NIC 210) in the backend data center networks, decomposes the fewer traffic flows originating from GPUs into a large number of flowlets, each mimicking a unique traffic flow to the leaf switches 204. This addresses the flow entropy problem within the backend data center networks caused due to lesser number of traffic flows. Further, as the flowlet-based NAT operation is implemented at NIC level, it is compatible with existing switching fabric without any infrastructural changes.

The computing system 200 depicted in FIG. 2 is shown as a simplified, conceptual computing system. Those skilled in the art will understand that a computing system 200 can include a large variety of devices (e.g., endpoint devices, leaf switches, and spine switches) and be arranged in a virtually limitless number of combinations based on the desired application and available deployment environment.

Although a specific embodiment for a computing system following a spine-leaf architecture suitable for carrying out the various steps, processes, methods, and operations described herein is discussed with respect to FIG. 2, any of a variety of systems and/or processes may be utilized in accordance with embodiments of the disclosure. For example, the computing system 200 can follow any network architecture such as ‘fat tree’ architecture. The elements depicted in FIG. 2 may also be interchangeable with other elements of FIGS. 1 and 3-8 as required to realize a particularly desired embodiment.

Referring to FIG. 3, a schematic block diagram of a part of an example computing system 300 that employs a flowlet-based NAT operation at NIC level for flow entropy management in accordance with various embodiments of the disclosure is shown. The embodiments of FIG. 3 show first through fourth GPUs 302A-D connected to a NIC 304, which is connected to a leaf switch 306. The leaf switch 306 can be further connected to three spine switches via a first uplink path 308A, a second uplink path 308B, and a third uplink path 308C, respectively. In FIG. 3, the first through fourth GPUs 302A-D are represented using distinct patterns and first through fourth traffic flows generated by these GPUs 302A-D are also represented with the same pattern as the respective GPUs 302A-D for the sake of illustration.

In many embodiments, the NIC 304 may be configured to receive the first through fourth traffic flows generated by the first through fourth GPUs 302A-D, respectively. The NIC 304 may be configured to apply a flowlet-based NAT operation on each of the first through fourth traffic flows for flow entropy management. For the sake of ongoing discussion, the flowlet-based NAT operation is described with respect to the first traffic flow generated by the first GPU 302A. Though in FIG. 3, the NIC 304 is shown to receive traffic flows from different GPUs, in several embodiments, the NIC 304 can also receive multiple traffic flows from a single GPU without deviating from the scope of the disclosure.

In a number of embodiments, the first traffic flow may include a plurality of packets, where each packet is separated from a preceding packet and a succeeding packet by some inter-packet gap. In some examples, “inter-packet gap” may refer to a duration of time between the transmission of two consecutive packets in a data transmission process. The NIC 304 may receive the plurality of packets as per the transmission sequence by the first GPU 302A and execute a flowlet identification process for each packet of the first traffic flow. In some examples, a “flowlet” may refer to a group of packets (e.g., one or more packets) within a traffic flow that are separated by a time duration greater than a threshold value from a preceding packet of the same traffic flow. Further, the inter-packet gap between two successive packets within the flowlet is less than the threshold value.

In a variety of embodiments, the NIC 304 may start the flowlet identification process when a start packet of the first traffic flow is received by the NIC 304, and for each received packet, the NIC 304 may be configured to identify, based on the inter-packet gap, whether the packet belongs to a previous flowlet or a new flowlet. For example, when an inter-packet gap between a current packet and a preceding packet is less than the threshold value, the NIC 304 may identify that the current packet belongs to the previous flowlet. However, when the inter-packet gap between the current packet and the preceding packet is greater than the threshold value, the NIC 304 may identify that the current packet belongs to a new flowlet. In such scenario, the NIC 304 may identify the current packet as the first packet of the new flowlet and the preceding packet as the last packet of the previous flowlet. In other words, the NIC 304 may identify one or more flowlets of the first traffic flow based on the inter-packet gap. In some scenarios, a flowlet can include a single packet. Such packet is separated by a duration greater than the threshold value from a preceding packet and also from a succeeding packet of the first traffic flow.

In still more embodiments, the threshold value can be a round-trip time (RTT) associated with a destination of the first traffic flow. In many examples, the RTT may correspond to the time taken for a packet to travel from a source to a destination and then back to the source. The NIC 304 can determine the RTT by using a static method or a dynamic method. In more embodiments, the NIC 304 can maintain one RTT-per destination. In additional embodiments, the NIC 304 can maintain one RTT globally for all destinations. For example, the NIC 304 may set the highest RTT as global RTT for all destinations.

In the static method, an average RTT for a destination is determined based on response times associated with packets sent to the destination. For example, the NIC 304 may determine the time (e.g., response time) it takes to receive an ACK or a NACK for each transmitted packet from a destination. The NIC 304 may then determine an average of these response times to determine the RTT associated with the destination.

In the dynamic method, the NIC 304 can determine the RTT by utilizing special probe packets. In an example scenario, the NIC 304 may transmit a probe packet, comprising a source timestamp, to a specific destination for which the RTT is to be determined. The NIC 304 may receive a probe response from the destination. The probe response may include the source timestamp and a destination processing time value. The destination processing time value may indicate the time taken at the destination to process the probe packet and generate the probe response. Further, the NIC 304 may determine a time of arrival of the probe response. The NIC 304 may utilize the source timestamp, the destination processing time value, and the time of arrival to determine the RTT for the destination. For example, the NIC 304 may subtract the source timestamp and the destination processing time value from the time of arrival to obtain the RTT associated with the destination. In some more examples, the NIC 304 may transmit multiple such probe packets to the destination and determine an average of RTTs to set the threshold value for the destination.

In FIG. 3, boxes 310A and 310B represent flowlets identified by the NIC 304 for the first traffic flow. Likewise, boxes 312A and 312B represent flowlets identified by the NIC 304 for the second traffic flow. Further, boxes 314A, 314B, and 314C represent flowlets identified by the NIC 304 for the third traffic flow and box 316 represents a flowlet identified by the NIC 304 for the fourth traffic flow. It should be appreciated by those skilled in the art that only a few flowlets are labeled in FIG. 3 for the sake of illustration. Further, boxes with the same pattern represent flowlets associated with the same traffic flow.

In still more embodiments, upon identifying a new flowlet within the first traffic flow, the NIC 304 may apply the NAT operation on the new flowlet. To apply the NAT operation, the NIC 304 may replace a source port value associated with the flowlet with a unique unused source port value. Typically, each packet contains a source port field in one of the packet headers and the source port field contains a source port value. Packets of the same traffic flow are associated with the same source port value. The source port field is a 16 bits long field, and thus, there can be 2¹⁶ unique source port values. The NIC 304 may maintain a flow table that stores outstanding flow state on a per-port basis of the NIC 304. For example, of the 2¹⁶ source port values, the values that are already assigned to outstanding traffic flows at a port are stored in the flow table. Thus, from the 2¹⁶ source port values, the values that are absent in the flow table can be considered unused. The NIC 304 may look-up in the flow table and select any value from the 2¹⁶ source port values that is absent in the flow table as a replacement candidate for the source port value associated with the new flowlet. In other words, the NIC 304 can select any of the unused source port values to replace the source port value associated with the flowlet. To replace the source port value with the unique unused source port value, the NIC 304 may re-write the unique unused source port value in the source port field of each packet in the identified flowlet. In other words, the NIC 304 associates each packet of the same flowlet with the same unused unique source port value until a new flowlet is identified. Once a unique source port value is assigned to a flowlet, the NIC 304 may update the flow table to store the unique unused source port value. As a result, the unique unused source port value no longer remains unused and cannot be assigned to any succeeding flowlet.

In still further embodiments, the NIC 304 may store a mapping between the source port value and the unique unused source port value in a mapping table for future look-up. The mapping table may be configured to store mapping information for all source port values replaced by the NIC 304. Such mapping table is accessible to both transmit path and a receive path in the NIC 304. Once the NAT operation is successfully applied, the NIC 304 may transmit the flowlet (e.g., each packet in the flowlet) to the leaf switch 306 for further routing.

In still additional embodiments, the leaf switch 306 may receive, from the NIC 304, a plurality of flowlets associated with each of the first through fourth traffic flows. Since each flowlet is associated with a different source port value due to the NAT operation applied by the NIC 304, each flowlet appears as a different traffic flow to the leaf switch 306. The leaf switch 306 may execute one or more load balancing operations on the plurality of flowlets to distribute the plurality of flowlets across various the first through third uplink paths 308A-C (e.g., ECMP paths). For example, the leaf switch 306 may execute an ECMP hashing scheme based on 5-tuple on the plurality of flowlets to distribute the plurality of flowlets across the first through third uplink paths 308A-C. As per the ECMP hashing scheme, the leaf switch 306 may apply the ECMP hashing algorithm on each packet to obtain a hash value and then select one of the first through third uplink paths 308A-C based on the hash value. For example, the leaf switch 306 may apply a modulo-3 function on the hash value to select one of the first through third uplink paths 308A-C. Typically, packets associated with the same 5-tuple combination are routed along the same uplink, thus preserving the order of packets and maintaining integrity of RDMA communication. Thus, packets belonging the same flowlet are routed through the same path. However, since each flowlet is associated with a unique 5-tuple combination due to the NAT operation, different flowlets belonging to the same traffic flow can be routed through different paths by the leaf switch 306. For example, flowlets represented by boxes 314B and 314C, though belong to the third traffic flow generated by the third GPU 302C, are routed on different uplink paths such as the first uplink path 308A and the third uplink path 308C, respectively.

In some more embodiments, the NIC 304 may be configured to receive response packets (e.g., ACKs or NACKs) in response to transmitting the plurality of flowlets. Each response packet may include, as a destination port value in a destination port field, the unique unused source port value associated with the corresponding flowlet. For example, if a flowlet was associated with a unique unused source port value “SP₁” during the NAT operation, one or more response packets received for the flowlet include “SP₁” as the destination port value in the destination port field.

In various embodiments, the NIC 304 may perform a reverse look-up in the mapping table accessible to the receive path and obtain the original source port value mapped to the unique unused source port value. The NIC 304 may then replace the destination port value in each response packet with the obtained source port value and transmit the response packet having the replaced source port value to a corresponding source port for further processing. For example, the NIC 304 may look-up in the mapping table and identify that the unique unused source port value “SP₁” obtained from destination port field is mapped to “OP₁”. Consequently, the NIC 304 may re-write “OP₁” in the destination port field of the response packet to restore the original source port value and transmit the response packet having the replaced source port value to a corresponding source port for further processing.

The reverse look-up ensures that the response packets of each of the first through fourth traffic flows have the same 5-tuple combination (e.g., source and destination IP addresses, source and destination port values, and protocol type) as originally assigned to the packets of the first through fourth traffic flows in the RDMA request. Thus, the NAT operation is transparent to higher levels of the RDMA protocol software and do not require any infrastructural changes or software modifications in them.

As the NAT operation applied by the NIC 304 decomposes the first through fourth traffic flows into the plurality of flowlets, each mimicking a unique traffic flow to the leaf switch 306, the leaf switch 306 may obtain flow level information of the first through fourth traffic flows based on one or more mapping tables stored at the NIC 304. For example, the leaf switch 306 may utilize a link layer handshake protocol (e.g., Link Layer Discovery Protocol) to obtain the content of the mapping table maintained by the NIC 304 on a port basis. The leaf switch 306 may then aggregate flowlets of each traffic flow based on the obtained mapping information and determine the flow level information of each of the first through fourth traffic flows based on the aggregation of the plurality of flowlets. Examples of the flow level information may include flow identifiers, QoS parameters (such as bandwidth allocation, priority class, latency requirements, or the like), active/inactive status of each traffic flow, or the like. In various embodiments, the leaf switch 306 may store the determined flow level information in various flow related databases (for example, NetFlow® feature developed by Cisco) associated with the leaf switch 306.

Although a specific embodiment for a computing system 300 employing a flowlet-based NAT operation at NIC level for flow entropy management suitable for carrying out the various steps, processes, methods, and operations described herein is discussed with respect to FIG. 3, any of a variety of systems and/or processes may be utilized in accordance with embodiments of the disclosure. For example, the NIC 304 may perform one of the static method or the dynamic method to periodically update the RTT associated with each destination. The elements depicted in FIG. 3 may also be interchangeable with other elements of FIGS. 1-2 and 4-8 as required to realize a particularly desired embodiment.

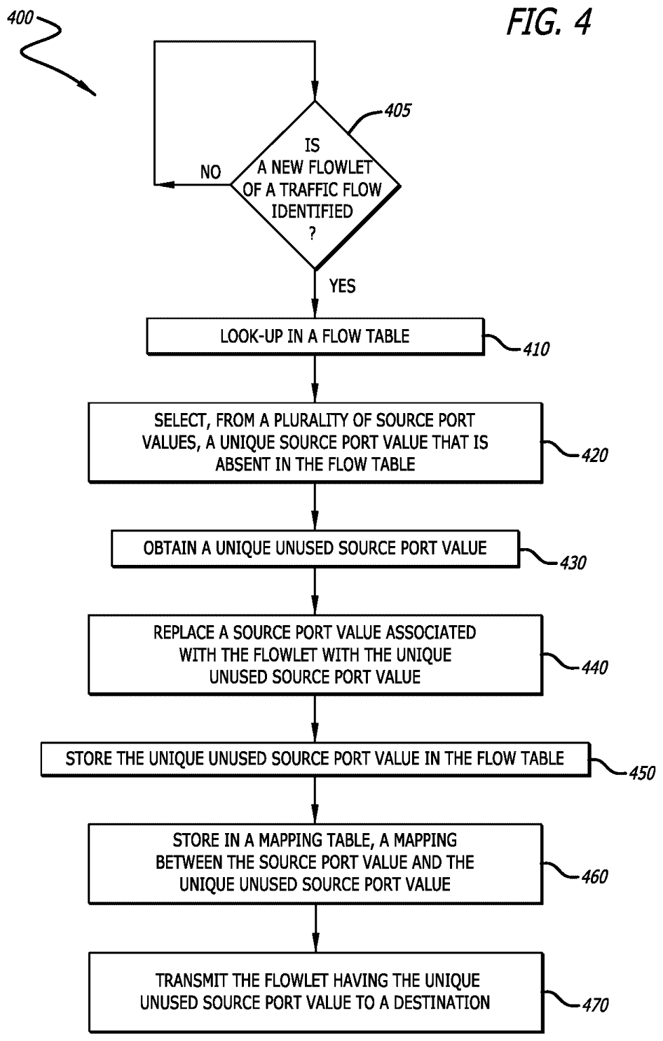

Referring to FIG. 4, a flowchart showing a process 400 for flow entropy management in accordance with various embodiments of the disclosure is shown. In many embodiments, the process 400 may determine if a new flowlet of a traffic flow is identified (block 405). The process 400 may start flowlet identification when a start packet of the traffic flow is received. For each received packet, the process 400 may identify whether the packet belongs to a previous flowlet or a new flowlet based on an inter-packet gap. For example, when an inter-packet gap between a current packet and a preceding packet is less than a threshold value, the process 400 may determine that a new flowlet is not identified and the current packet belongs to a previous flowlet. However, when the inter-packet gap between the current packet and the preceding packet is greater than the threshold value, the process 400 may determine that the new flowlet is identified, and the current packet is the first packet of the new flowlet. In a number of embodiments, the threshold value may refer to an RTT associated with the destination of the traffic flow.

In a variety of embodiments, when a new flowlet is not identified, the process 400 may again perform flowlet identification (block 405). However, if a new flowlet is identified, the process 400 may look-up in a flow table (block 410). In additional embodiments, the process 400 may maintain the flow table that stores outstanding flow state on a per-port basis. For example, a source port field in packet headers is a 16 bits long field, and thus, there can be 2¹⁶ unique source port values. Of the 2¹⁶ source port values, the values that are already assigned to outstanding traffic flows at a port are stored in the flow table. In numerous embodiments, the flowlet may be associated with a source port value associated with the traffic flow. The source port value may be included in the flow table as it is assigned to the traffic flow of the flowlet.

In more embodiments, the process 400 may select, from a plurality of source port values, a unique source port value that is absent in the flow table (block 420). For example, from the 2¹⁶ source port values, the values that are absent in the flow table can be considered unused. The process 400 can select any value from the 2¹⁶ source port values that is absent in the flow table based on the look-up performed on the flow table.

In additional embodiments, the process 400 may obtain a unique unused source port value (block 430). For example, the process 400 may obtain the unique unused source port value in response to identifying the flowlet. The process 400 may obtain the unique unused source port value based on the selection of any value from the 2¹⁶ source port values that is absent in the flow table.

In further embodiments, the process 400 may replace the source port value associated with the flowlet with the unique unused source port value (block 440). For example, to replace the source port value with the unique unused source port value, the process 400 may re-write the unique source port value in the source port field of each packet in the identified flowlet. In other words, the process 400 may associate each packet of the new flowlet with the same unused unique source port value until another new flowlet is identified. Re-writing the unique unused source port value in the source port field of each packet of the new flowlet makes 5-tuple combination of the new flowlet be different from the 5-tuple combination associated with a preceding flowlet. In some examples, the 5-tuple combination can include source and destination IP addresses, source and destination port values, and protocol type.

In several embodiments, the process 400 may store the unique unused source port value in the flow table (block 450). In numerous additional embodiments, in response to the replacement of the source port value with the unique unused source port value, the process 400 may store the unique unused source port value in the flow table. Thus, making the unique unused source port value unavailable for a succeeding new flowlet.

In still more embodiments, the process 400 may store in a mapping table, a mapping between the source port value and the unique unused source port value (block 460). In still further embodiments, the mapping table may store mapping information for all source port values replaced by the process 400. Such mapping table is accessible to both transmit path and a receive path of a NIC.

In still additional embodiments, the process 400 may transmit the flowlet having the unique unused source port value to a destination (block 470). For example, once a packet of the flowlet is associated with the unique unused source port value, the process 400 transmits the packet to a connected leaf switch for further routing and moves to the next packet of the flowlet for re-writing the unique unused source port value in the source port field. As a result, all packets of the flowlet are associated with the unique unused source port value and transmitted to the destination.

Although a specific embodiment for flow entropy management suitable for carrying out the various steps, processes, methods, and operations described herein is discussed with respect to FIG. 4, any of a variety of systems and/or processes may be utilized in accordance with embodiments of the disclosure. For example, the process 400 may employ various methods, such as a static method or a dynamic method, to determine the RTT associated with the destination. The elements depicted in FIG. 4 may also be interchangeable with other elements of FIGS. 1-3 and 5-8 as required to realize a particularly desired embodiment.

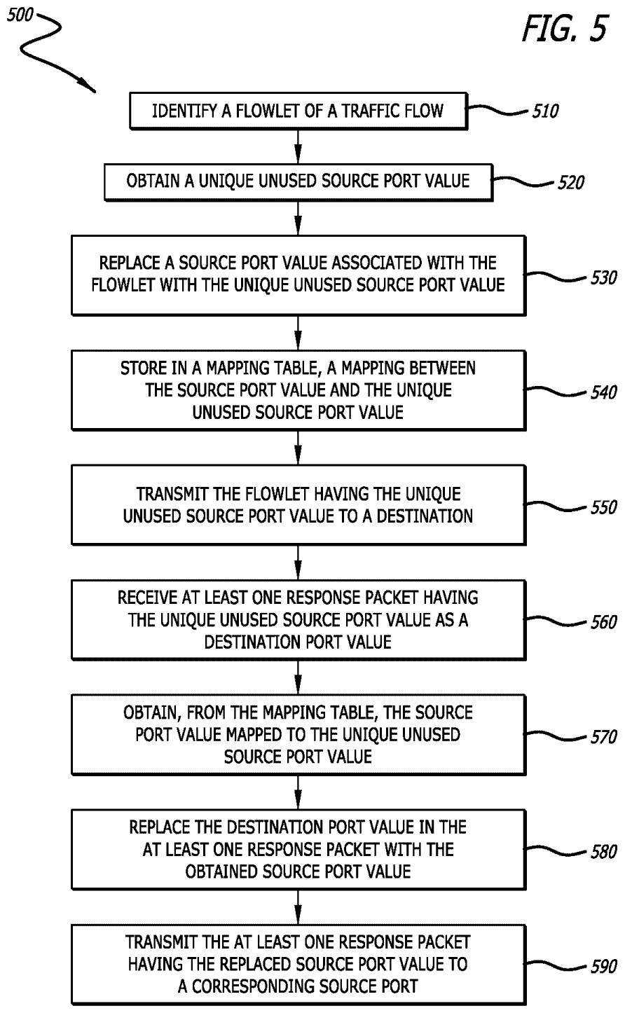

Referring to FIG. 5, a flowchart showing a process 500 for flow entropy management in accordance with various embodiments of the disclosure is shown. In many embodiments, the process 500 identify a flowlet of a traffic flow (block 510). The process 500 may start flowlet identification when a start packet of the traffic flow is received. For each received packet, the process 500 may identify whether the packet belongs to a previous flowlet or a new flowlet based on an inter-packet gap. For example, when an inter-packet gap between a current packet and a preceding packet is less than a threshold value, the process 500 may determine that a new flowlet is not identified and the current packet belongs to a previous flowlet. However, when the inter-packet gap between the current packet and the preceding packet is greater than the threshold value, the process 500 may determine that the new flowlet is identified and the current packet is the first packet of the new flowlet and the preceding packet is identified as the last packet of the previous flowlet.

In a variety of embodiments, the process 500 may obtain a unique unused source port value (block 520). For example, the process 500 may look-up in a flow table to obtain the unique unused source port value. The flow table may store outstanding flow state on a per-port basis. For example, source port values that are already assigned to outstanding traffic flows or flowlets are stored in the flow table. The process 500 may select, from a plurality of source port values, a unique source port value that is absent in the flow table. For example, from all available source port values, the values that are absent in the flow table can be considered unused by the process 500.

In additional embodiments, the process 500 may replace a source port value associated with the flowlet with the unique unused source port value (block 530). To replace the source port value with the unique unused source port value, the process 500 may re-write the unique source port value in a source port field of each packet in the identified flowlet. In other words, the process 500 may associate each packet of the identified flowlet with the same unused unique source port value until another new flowlet is identified. In numerous additional embodiments, based on the association of the unique unused source port value with the identified flowlet, the process 500 may store the unique unused source port value in the flow table. Thus, making the unique unused source port value unavailable for a succeeding new flowlet.

In more embodiments, the process 500 may store in a mapping table, a mapping between the source port value and the unique unused source port value (block 540). In additional embodiments, the mapping table may store mapping information for all source port values replaced by the process 500. Such mapping table is accessible to both transmit path and a receive path of a NIC.

In further embodiments, the process 500 may transmit the flowlet having the unique unused source port value to a destination (block 550). For example, once a packet of the flowlet is associated with the unique unused source port value, the process 500 transmits the packet to a connected leaf switch for further routing and moves to the next packet of the flowlet for re-writing the unique unused source port value in the source port field. As a result, all packets of the flowlet are associated with the unique unused source port value and transmitted to the destination.

In still more embodiments, the process 500 may receive at least one response packet having the unique unused source port value as a destination port value (block 560). The process 500 may receive the at least one response packet from the destination in response to transmitting the flowlet to the destination. The response packet may include, as the destination port value in a destination port field, the unique unused source port value associated with the corresponding flowlet. For example, if the flowlet was associated with the unique unused source port value “SP₁”, the response packet received for the flowlet include “SP₁” as the destination port value in the destination port field.

In many further embodiments, the process 500 may obtain, from the mapping table, the source port value mapped to the unique unused source port value (block 570). For example, the process 500 may perform a reverse look-up in the mapping table to obtain the source port value mapped to the unique unused source port value. For example, the process 500 may look-up in the mapping table and identify that the unique unused source port value “SP₁” obtained from destination port field is mapped to “OP₁”.

In several embodiments, the process 500 may replace the destination port value in the at least one response packet with the obtained source port value (block 580). To replace the destination port value in the response packet, the process 500 may re-write the source port value obtained from the mapping table in the destination port field. For example, the process 500 may re-write “OP₁” in the destination port field of the response packet to restore the original source port value.

In various embodiments, the process 500 may transmit the at least one response packet having the replaced source port value to a corresponding source port (block 590). Since the source port receives the response packet with the original source port value associated with the traffic flow, NAT operation performed on the packets of the flowlet is transparent to the source port. The source port may process the response packet to determine whether the corresponding packet was successfully delivered to the destination or requires retransmission. In some examples, the response packet can be an ACK response or a NACK response.

Although a specific embodiment for flow entropy management suitable for carrying out the various steps, processes, methods, and operations described herein is discussed with respect to FIG. 5, any of a variety of systems and/or processes may be utilized in accordance with embodiments of the disclosure. For example, a leaf switch that receives the flowlets may perform one or more load balancing operations on the flowlets to distribute the flowlets across various available uplink paths. As successive flowlets are separated at least by the RTT associated with the destination, the flowlets in spite of being routed through different uplink paths by the leaf switch may reach the destination in the same order as the transmission sequence, thus preserving the order of packets and maintaining integrity of RDMA communication. The elements depicted in FIG. 5 may also be interchangeable with other elements of FIGS. 1-4 and 6-8 as required to realize a particularly desired embodiment.

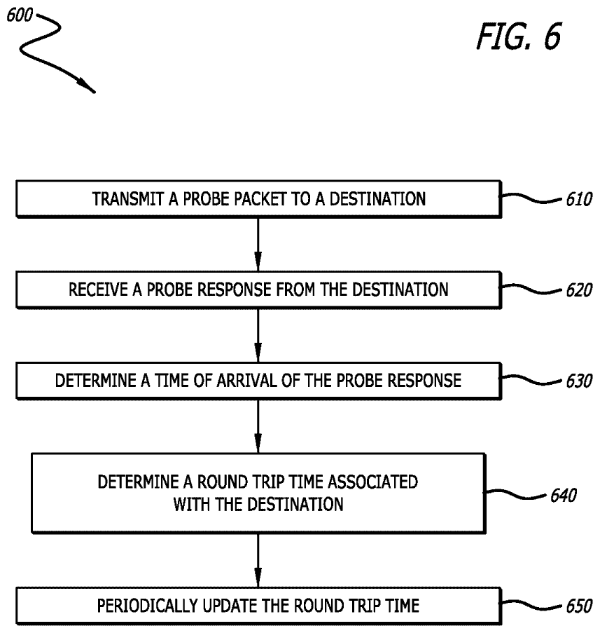

Referring to FIG. 6, a flowchart showing a process 600 for determining an RTT associated with a destination in accordance with various embodiments of the disclosure is shown. In many embodiments, the process 600 may transmit a probe packet to a destination (block 610). The destination can be a specific destination for which the RTT is to be determined. The probe packet may include a source timestamp. The source time stamp may indicate a time instance at which the probe packet was transmitted by the process 600.

In a number of embodiments, the process 600 may receive a probe response from the destination (block 620). In more embodiments, the probe packet may be processed at the destination and in response the destination may generate the probe response. The probe response may include the source timestamp and a destination processing time value. The destination processing time value may indicate the time taken at the destination to process the probe packet and generate the probe response.

In a variety of embodiments, the process 600 may determine a time of arrival of the probe response (block 630). The time of arrival may indicate a time instance when the probe response is received by the process 600. The process 600 may further extract the source timestamp and a destination processing time value from the probe response.

In still further embodiments, the process 600 may determine an RTT associated with the destination (block 640). In several embodiments, the process 600 may utilize the source timestamp, the destination processing time value, and the time of arrival to determine the RTT for the destination. For example, the process 600 may subtract the source timestamp and the destination processing time value from the time of arrival to obtain the RTT associated with the destination.

In numerous embodiments, the process 600 may periodically update the RTT (block 650). Network may be susceptible to changes over time, for example due to congestion, bandwidth variation, etc. Thus, the process 600 may periodically update the RTT to capture such changes in the network.

Although a specific embodiment for incast congestion management suitable for carrying out the various steps, processes, methods, and operations described herein is discussed with respect to FIG. 6, any of a variety of systems and/or processes may be utilized in accordance with embodiments of the disclosure. For example, as a probe packet can be routed via one of the many available paths, the process 600 may transmit multiple probe packets to the destination to capture different RTTs associated with the destination. The process 600 may then determine an average of these RTTs to obtain the actual RTT of the destination. The elements depicted in FIG. 6 may also be interchangeable with other elements of FIGS. 1-5, 7, and 8 as required to realize a particularly desired embodiment.

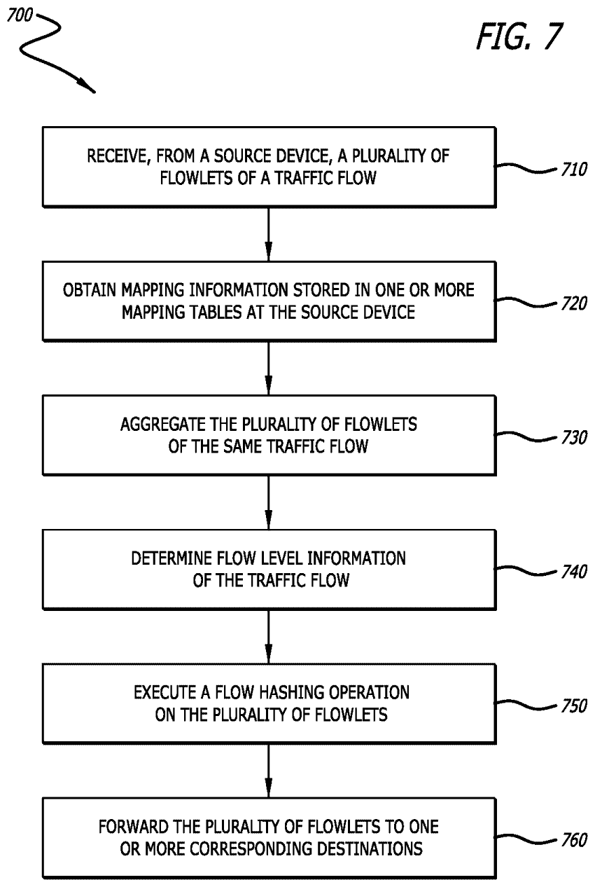

Referring to FIG. 7, a flowchart showing a process 700 for routing NAT-operated flowlets of a traffic flow in accordance with various embodiments of the disclosure is shown. In many embodiments, the process 700 may receive, from a source device, a plurality of flowlets of a traffic flow (block 710). In additional embodiments, a NIC at the source device may have applied a NAT operation on the plurality of flowlets to associate each flowlet with a unique source port value (e.g., a proxy source port value). Since each flowlet has a different source port value, the process 700 may consider each flowlet as a different traffic flow.

In a number of embodiments, the process 700 may obtain mapping information stored in one or more mapping tables at the source device (block 720). For example, the process 700 may utilize a link layer handshake protocol (e.g., Link Layer Discovery Protocol) to obtain the content of the mapping table maintained by the NIC on a port basis. The mapping tables may refer to network address translation tables that store mapping between original source port values and proxy source port values assigned to the plurality of flowlets.

In a variety of embodiments, the process 700 may aggregate the plurality of flowlets of the same traffic flow (block 730). The process 700 may aggregate the plurality of flowlets based on the obtained mapping information. For example, the process 700 may perform a look-up in the obtained mapping information based on the proxy source port values and identify flowlets having the same original source port value. Flowlets having the same original source port value are aggregated as the same traffic flow.

In still further embodiments, the process 700 may determine flow level information of the traffic flow (block 740). As the NAT operation applied by the NIC decomposes the traffic flow into the plurality of flowlets, each mimicking a unique traffic flow to the process 700, the process 700 may obtain flow level information of the traffic flow based on the aggregation of the plurality of flowlets. Examples of the flow level information may include flow identifiers, QoS parameters (such as bandwidth allocation, priority class, latency requirements, or the like), active/inactive status of each traffic flow, or the like.

In some more embodiments, the process 700 may execute a flow hashing operation on the plurality of flowlets (block 750). The process 700 may execute flow hashing operation on the plurality of flowlets to distribute the plurality of flowlets across a plurality of ECMP paths. In several embodiments, the process 700 may execute the flow hashing based on 5-tuple on the plurality of flowlets to distribute the plurality of flowlets across the plurality of ECMP paths. For example, the process 700 may apply an ECMP hashing algorithm on a 5-tuple combination of a packet and obtain a hash value. The process 700 may further apply a modulo-n function on the hash value to select one of the plurality of paths. Here, ‘n’ may refer to a count of the plurality of ECMP paths.

In numerous embodiments, the process 700 may forward the plurality of flowlets to one or more corresponding destinations (block 760). For example, the process 700 may forward the plurality of flowlets based on the path selected for the corresponding flowlet. In several more embodiments, packets associated with the same 5-tuple combination are routed along the same path. Since all the packets belonging to the same flowlet have the same 5-tuple combination, the packets of the same flowlet are routed through the same path. However, each flowlet is associated with a unique 5-tuple combination due to the NAT operation. Thus, different flowlets belonging to the same traffic flow can be routed through different paths by the process 700. Therefore, by decomposing a traffic flow into multiple flowlets, each mimicking a different traffic flow, the hash distribution algorithms can operate on the flowlets without any bias, resulting in effective load balancing and effective flow entropy management. Further, as successive flowlets in the traffic flow are separated at least by the RTT associated with the destination, the flowlets in spite of being forwarded through different paths may reach the destination in the same order as the transmission sequence, thus preserving the order of packets and maintaining integrity of RDMA communication.

Although a specific embodiment for routing NAT-operated flowlets of a traffic flow suitable for carrying out the various steps, processes, methods, and operations described herein is discussed with respect to FIG. 7, any of a variety of systems and/or processes may be utilized in accordance with embodiments of the disclosure. For example, the process 700 can utilize any load balancing technique to distribute the plurality of flowlets across available uplinks. In some examples, the process 700 may distribute the plurality of flowlets across congestion free paths only. The elements depicted in FIG. 7 may also be interchangeable with other elements of FIGS. 1-6 and 8 as required to realize a particularly desired embodiment.

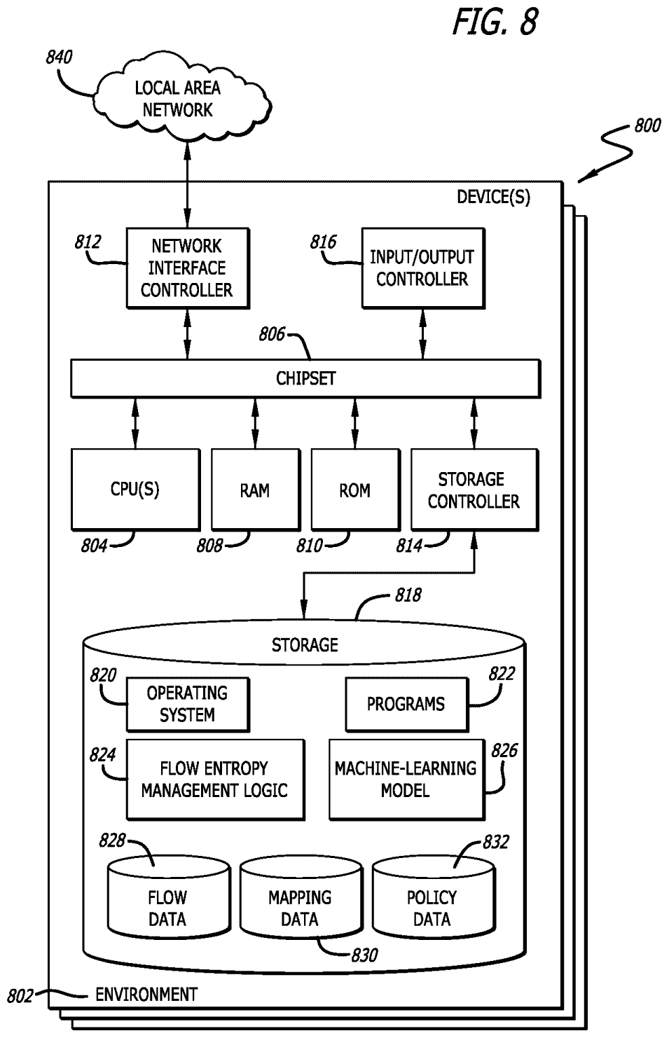

Referring to FIG. 8, a conceptual block diagram for one or more devices 800 capable of executing components and logic for implementing the functionality and embodiments described above is shown. The embodiment of the conceptual block diagram depicted in FIG. 8 can illustrate a conventional server computer, workstation, desktop computer, laptop, tablet, network appliance, e-reader, smartphone, or other computing device, and can be utilized to execute any of the application and/or logic components presented herein. The device 800 may, in some examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, central processing units (“CPUs”) can be configured to operate in conjunction with a chipset 806. The processor(s) 804 can be standard programmable CPUs that perform arithmetic and logical operations necessary for the operation of the device 800.

In additional embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in additional embodiments. The chipset 806 can further be configured to provide an interface to a computer-readable storage medium such as a read-only memory (“ROM”) 810 or non-volatile RAM (“NVRAM”) 808 for storing basic routines that can help with various tasks such as, but not limited to, starting up the device 800 and/or transferring information between the various components and devices. The ROM 810 or NVRAM 808 can also store other application components necessary for the operation of the device 800 in accordance with various embodiments described herein.

Different embodiments of the device 800 can be configured to operate in a networked environment using logical connections to remote computing devices and computer systems through a network, such as the network 840. The chipset 806 can include functionality for providing network connectivity through a network interface card (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for example, store an operating system 820, applications 822, and data 828, 830, 832, which are described in greater detail below. The storage 818 can be connected to the environment 802 through a storage controller 814 connected to the chipset 806. In various embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

For example, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In various embodiment, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as application 822 and transform the device 800 by specifying how the processor(s) 804 can transition between states, as described above. In additional embodiments, the device 800 has access to computer-readable storage media storing computer-executable instructions which, when executed by the device 800, perform the various processes described above with regard to FIGS. 1-8. In more embodiments, the device 800 can also include computer-readable storage media having instructions stored thereupon for performing any of the other computer-implemented operations described herein.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8, and can include other components that are not explicitly shown in FIG. 8, or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

In many embodiments, the device 800 can include a flow entropy management logic 824 that can be configured to perform one or more of the various steps, processes, operations, and/or other methods that are described above. Often, the flow entropy management logic 824 can be a set of instructions stored within a non-volatile memory that, when executed by the processor(s)/controller(s) 804 can carry out these steps, etc. In additional embodiments, the flow entropy management logic 824 may be a client application that resides on a network-connected device, such as, but not limited to, a server, switch, personal or mobile computing device, an access point (AP). In various embodiments, the flow entropy management logic 824 may utilize a flowlet-based NAT operation on packets of a traffic flow to decompose the traffic flow into multiple flowlets, each flowlet having a unique 5-tuple combination, to manage flow entropy.

In several embodiments, the flow entropy management logic 824 can enable the device 800 (for example, a NIC) to identify a plurality of flowlets within a traffic flow and replace a source port value associated with each flowlet with a unique unused source port value by referring a flow table. The flow entropy management logic 824 may obtain the unique unused source port values through a look-up in a flow table. In numerous embodiments, the flow entropy management logic 824 may enable the device 800 (e.g., the NIC) to transmit the plurality of flowlets, each having the corresponding unique unused source port value, to a destination. In more embodiments, the flow entropy management logic 824 may determine RTTs associated with various destinations and utilize the determined RTTs for flowlet identification. The flow entropy management logic 824 can utilize a static method or a dynamic method for determining the RTTs. In further embodiments, the flow entropy management logic 824 may enable the device 800 (e.g., the NIC) to perform a reverse NAT operation on response packets received for the plurality of flowlets and transmit the response packets correct source ports for further processing.

In numerous additional embodiments, the flow entropy management logic 824 (when implemented at a switch) may cause the device 800 to utilize a link layer handshake protocol (e.g., Link Layer Discovery Protocol) to obtain information from mapping tables maintained at NICs of endpoint devices. The flow entropy management logic 824 may utilize the mapping information to aggregate flowlets of the same traffic flow and determine flow level information of the traffic flow based on the aggregated flowlets.

In a number of embodiments, the storage 818 can include flow data 828. In additional embodiments, flow data 828 can include information, for example, flow tables. A flow table may maintain an outstanding flow state on a per-port basis of the device 800. For example, of 2¹⁶ possible source port values, values that are already assigned to outstanding traffic flows at a port are stored in the flow table for look-up during the NAT operation. From the 2¹⁶ source port values, the values that are absent in the flow table are considered unused and can be selected for the NAT operation. Once an unused source port value is assigned to a flowlet by the flow entropy management logic 824, the unused source port value is then added to the flow table as a record.

In still more embodiments, the storage 818 can include mapping data 830. Mapping data 830 may include at least one mapping table for a transmit path of the device 800. Each mapping table may store mapping information for all source port values replaced by the flow entropy management logic 824. For example, during the NAT operation, the flow entropy management logic 824 may replace a source port value associated with a unique unused source port value. The mapping between the source port value and the unique unused source port value is stored in the mapping table for record. The mapping table can be further utilized by the flow entropy management logic 824 to perform a reverse NAT operation on response packets of the flowlet. In still more embodiments, the mapping table is accessible to both the transmit path and a receive path in the device 800.

In various embodiments, the storage 818 can include policy data 832. In several embodiments, the policy data 832 can comprise information regarding access control lists. Access control lists may delineate a sets of rules that determine what type of traffic is allowed or denied on the network. The set of rules can be based on various criteria such as source or destination IP addresses, port numbers, or communication protocols. In several more embodiments, the policy data 832 can include QoS policies. For example, QoS policies can be used to prioritize certain types of traffic over others to ensure that critical applications receive necessary latency requirements. In numerous additional embodiments, the policy data 832 can further include security policies, authentication and authorization policies, or the like.

Finally, in many embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826. The ML model 826 may be configured to learn traffic patterns associated with congestion events based on data related to historical congestion events. Such predictions may enable traffic routing by network switches over less congested paths.

The ML model(s) 826 can be configured to generate inferences to make predictions or draw conclusions from data. An inference can be considered the output of a process of applying a model to new data. This can occur by learning from infrastructure data, sustainability data, and/or health data and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a network interface controller (NIC) configured to provide access to a network; and
a memory communicatively coupled to the processor, wherein the memory comprises a flow entropy management logic that is configured to:
identify a flowlet of a traffic flow, wherein the flowlet is associated with a source port value;
obtain a unique unused source port value in response to identifying the flowlet;
replace the source port value associated with the flowlet with the unique unused source port value; and
transmit the flowlet having the unique unused source port value to a destination.

2. The device of claim 1, wherein the flowlet comprises at least one packet.

3. The device of claim 2, wherein one or more headers of the at least one packet comprise the source port value.

4. The device of claim 3, wherein replacing the source port value comprises replacing the source port value in the one or more headers of the at least one packet with the unique unused source port value.

5. The device of claim 1, wherein the flow entropy management logic identifies the flowlet based on an inter-packet gap exceeding a threshold value.

6. The device of claim 5, wherein the threshold value is a round-trip time associated with the destination.

7. The device of claim 6, wherein the flow entropy management logic is further configured to determine the round-trip time associated with the destination.

8. The device of claim 7, wherein the flow entropy management logic determines the round-trip time based on one or more response times associated with the destination.

9. The device of claim 7, wherein to determine the round-trip time, the flow entropy management logic is further configured to:
transmit a probe packet to the destination, wherein the probe packet comprises a source timestamp;
receive a probe response from the destination in response to transmitting the probe packet, wherein the probe response comprises the source timestamp and a destination processing time value; and
determine a time of arrival of the probe response, wherein the round-trip time is determined based on the source timestamp, the destination processing time value, and the time of arrival.

10. The device of claim 7, wherein the flow entropy management logic is further configured to periodically update the round-trip time associated with the destination.

11. The device of claim 1, wherein to obtain the unique unused source port value, the flow entropy management logic is further configured to:
look-up in a flow table; and
select, from a plurality of source port values, a unique source port value that is absent in the flow table, wherein the selected unique source port value corresponds to the unique unused source port value.

12. The device of claim 11, wherein the flow entropy management logic is further configured to store the unique unused source port value in the flow table in response to the replacement of the source port value with the unique unused source port value.

13. The device of claim 11, wherein the flow table is configured to maintain an outstanding flow state on a per-port basis of the device.

14. The device of claim 1, wherein the flow entropy management logic is further configured to store in a mapping table, a mapping between the source port value and the unique unused source port value.

15. The device of claim 14, wherein the flow entropy management logic is further configured to:
receive at least one response packet in response to transmitting the flowlet, wherein the at least one response packet comprises, as a destination port value, the unique unused source port value;
obtain, from the mapping table, the source port value mapped to the unique unused source port value;
replace the destination port value in the at least one response packet with the obtained source port value; and
transmit the at least one response packet having the replaced source port value to a corresponding source port.

16. The device of claim 1, wherein the NIC is further configured to execute the flow entropy management logic.

17. A device, comprising:
a processor;
a network interface controller configured to provide access to a network; and
a memory communicatively coupled to the processor, wherein the memory comprises a flow entropy management logic that is configured to:
receive, from a source device, a plurality of flowlets of a traffic flow, wherein the plurality of flowlets are associated with unique source port values;
obtain mapping information stored in one or more mapping tables at the source device;
aggregate the plurality of flowlets based on the obtained mapping information; and
determine flow level information of the traffic flow based on the aggregation of the plurality of flowlets.

18. The device of claim 17, wherein the mapping information is obtained based on a link layer handshake protocol with the source device.

19. The device of claim 17, wherein the flow entropy management logic is further configured to execute a flow hashing operation on the plurality of flowlets to forward the plurality of flowlets to one or more corresponding destinations.

20. A method, comprising:
identifying a flowlet of a traffic flow, wherein the flowlet is associated with a source port value;
obtaining a unique unused source port value in response to identifying the flowlet;
replacing the source port value associated with the flowlet with the unique unused source port value; and
transmitting the flowlet having the unique unused source port value to a destination.
